(19) United States
(12) Patent Application Publication
(10) Pub. No.: US 2003/0196872 A1
(43) Pub. Date: Oct. 23, 2003

(54) Stop mechanism for assembly line

(76) Inventors: Bruce H. Whittle, Plymouth, MI (US); Michael L. Shepherd, Caseville, MI (US); Louis J. Rich, Shelby TWP, MI (US); Daniel E. Hawkins, Milford, MI (US); Ronald J. Verhelle, Northville, MI (US)

Correspondence Address: HARNESS, DICKEY & PIERCE, P.L.C., P.O. BOX 828, BLOOMFIELD HILLS, MI, 48303, US

(21) Appl. No.: 10/127,014

(22) Filed: Apr. 19, 2002

(51) Int. Cl. B65G 43/00

(52) U.S. Cl. 198/463.4

(57) ABSTRACT

A stop for stopping moving articles on a conveyor system is disclosed. The stop has a base and a stop arm, which are operable to stop the moving object. The stop arm is rotatable about a location on the base and is translatable generally perpendicular to the conveyor. An actuator arm is coupled to the stop arm to regulate the movement of the stop arm. A cam follower is coupled to the actuator arm to rotate said actuator arm. A linkage is rotatably mounted to said stop arm and slidably mounted to the base to control the movement of the stop arm.

### FIELD OF THE INVENTION

The present invention relates to an assembly line mechanism and, more particularly, to a stop mechanism for moving articles on an assembly line.

### BACKGROUND OF THE INVENTION

Assembly conveyor systems often incorporate pneumatic deceleration stop assemblies on the conveyor track to decelerate pallets or moving articles and position them accurately for machining and assembly operations. The use of these pneumatic stops on conveyor systems increase the number of skilled mechanics required for installation and maintenance of the stop and, hence, the lifetime cost of the conveyor system.

### SUMMARY OF THE INVENTION

In accordance with the present invention, a stop for stopping moving articles on a conveyor system which overcomes the disadvantages of the prior art is disclosed. In another aspect of the present invention, the stop has a base and a stop arm which is operable to stop a pallet. A further aspect of the present invention provides a stop arm which is rotatable about a location on the base and is translatable generally perpendicular to the conveyor. In yet another aspect of the present invention, an actuator arm is coupled to the stop arm to regulate the movement of the stop arm. A cam follower is coupled to the actuator arm to rotate said actuator arm. A linkage rotatably mounted to said stop arm and slidably mounted to the base.

In accordance with another aspect of the invention as is shown in a second embodiment, a pallet stop for stopping a pallet on a conveyor system is disclosed. The pallet stop has a base, and a stop arm which is rotatable and translatable with respect to the base. The stop arm has a first pallet engaging position and a second pallet releasing position. An actuator arm is coupled to said stop arm which is configured to regulate the translation of the said stop arm. A linkage is also coupled to said stop arm which is configured to regulate the rotation of said stop arm. The actuator arm and linkage regulate the stop arm movement from its first pallet engaging position to its pallet releasing position.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of the preferred embodiment of a stop mechanism of the current invention;

FIG. 2 is an exploded perspective view of the stop mechanism of the present invention;

FIG. 3 is a side elevational view of the stop mechanism of the present invention shown in an advanced position;

FIG. 4 is a side elevational view of the stop mechanism of the present invention in its first actuated position;

FIG. 5 is a side elevational view of the stop mechanism of the present invention in its fully retracted and disengaged position; and

FIG. 6 is a side elevational view of the stop mechanism of the present invention in a position to accept a second pallet of a conveyor system.

### DETAILED DESCRIPTION OF THE PREFERRED EMBODIMENT

The following description of the preferred embodiment is merely exemplary in nature and is in no way intended to limit the invention, its application, or uses.

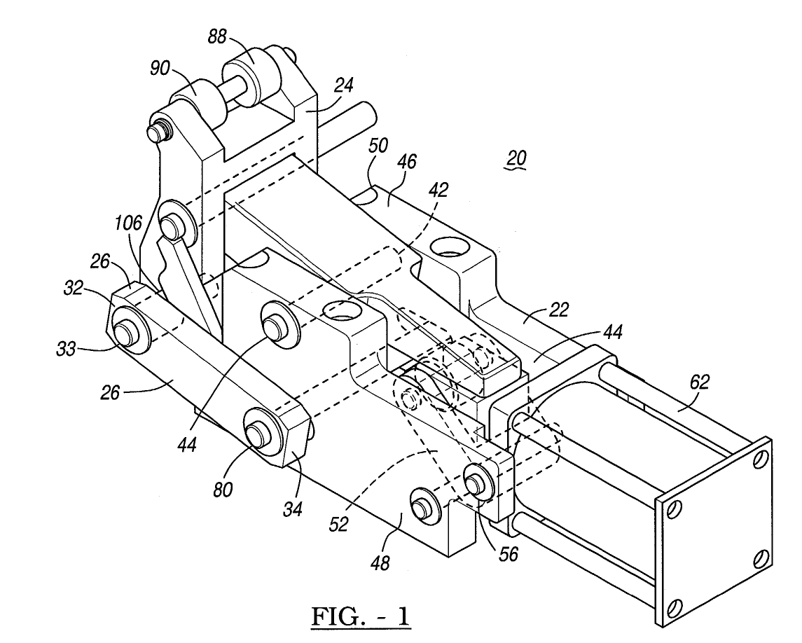

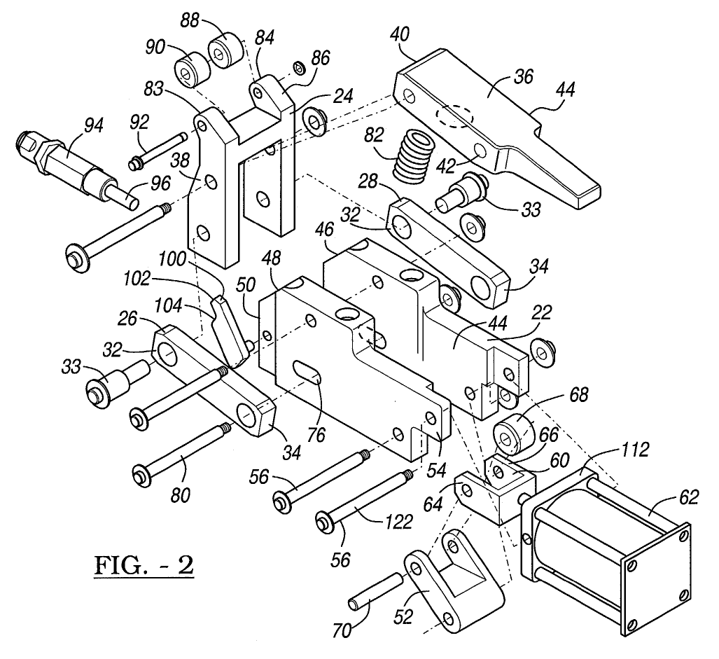

Referring generally to FIGS. 1 and 2, the preferred embodiment of a stop mechanism 20 of the present invention includes a stop body 22 which functions to rotatably mount several members of a four-bar linkage assembly to stop a pallet 26 or other moveable article or object such as a box, crate, engine block workpiece, crank shaft workpiece or the like, on an industrial conveyor system. Although the pallet stop is shown in use with a chain driven conveyor, stop mechanism 20 is equally usable with other conveyor systems such as an electric motor driven roller system. Such a system is disclosed in U.S. Pat. No. 5,881,862, entitled “Torque Limiting Roller Drive for Conveyors” and U.S. Pat. No. 4,960,202 entitled “Friction Control for Bearing Surface of Roller,” which are incorporated by reference herein. Positioned generally below the conveyor, stop mechanism 20 includes a generally H-shaped stop arm 24 which functions to stop the pallet at a specific location on a conveyor system. Stop arm 24 is coupled to stop body 22 by a pair of links 26 and 28. Each link 26 and 28 is rotatably coupled to the lower end 30 of stop arm 24 at its first end 32 by coupling pin 33 and rotatably and slidably coupled to the stop body 22 at its second end 34. Stop arm 24 is further coupled to the stop body 22 by an actuator arm 36. Actuator arm 36 is rotatably coupled to the central portion 38 of stop arm 24 at its first end 40, and is rotatably coupled to stop body 22 at a central location 42. Actuator arm 36 is rotatable within stop body 22 about a central location cavity 44.

Stop body 22 is generally formed by a pair of spaced apart planar members 46 and 48. Generally disposed within these members 46 and 48 is stop arm 24 which is located at a first end 50 of stop body 22 and a pivot arm 52 located at a second end 54 of stop body 22. Pivot arm 52 is generally U-shaped and is rotatably coupled to the second end 54 of stop body 22 via a through pin 56. Upper portion 58 of pivot arm 52 is adapted to engage a clevis 60 which is functionally coupled to a solenoid drive 62. Supported between first 64 and second 66 arms of clevis 60 is a cam follower 68 on a pin 70 which engages the lower surface of the second end of the actuator.

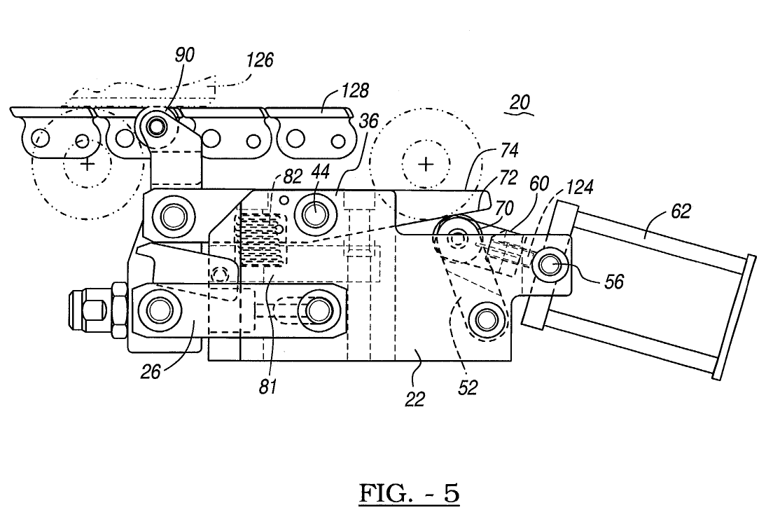

Stop body 22 defines a pair of generally horizontal slots 76 and 78, which are disposed in the generally parallel members 46 and 48. Horizontal slots 76 and 78 allow the rotational and sliding coupling of the pair of links 26 and 28 to stop body 22. The links 26 and 28 are coupled to stop body 22 by the use of a through pin 80 disposed within the generally horizontal slots 76 and 78. Referring briefly to FIG. 5, stop body 22 further has a central base 21 which supports a coil spring member 82. The coil spring member 82 which is disposed between stop body 22 and actuating arm 36, functions to bias the first end 40 of actuating arm 36 in an up position.

Stop arm 24 has a pair of generally vertical arms 83 and 84. Disposed between the first ends 86 of generally vertical arms 83 and 84 is a pair of urethane stop wheels 87 and 90. Urethane stop wheels 87 and 90 are rotatably held between the vertical arms 83 and 84 by a through pin 92.

Disposed between vertical arms 83 and 84 at the lower end 32 of stop arm 22 is a shock assembly 94. Shock assembly 94 has a piston drive member 96, which is operably coupled to the through pin 80. Through pin 80 is disposed within the pair of slots 76 and 78. Shock assembly 94 functions to bias through pin 80 toward a first end 98 of slots 76 and 78. The shock assembly 94 further acts to absorb transmitted energy from the pallet as stop arm 24 moves from its stop position to its engaged position (87′).

Disposed between link 26 and exterior surface 98 of the stop body 22 is a latch 100. The latch 100 has a tooth 102 with a tooth bearing surface 104. Tooth bearing surface 104 functions to support a first through pin bearing surface 106. Additionally, latch 100 has a first sliding surface 108, which slides against a second through pin bearing surface 110.

Solenoid 62 is mounted on a trunnion mounting 112, which is formed of a pair of plates 114 and 116 separated by spacer bars 118. First plate 114 defines a through hole 120 which is used to rotatably couple trunnion mounting 112 to second end 54 of the stop body 22 using through pin 122. Solenoid 62 has an actuatable member 124, which can be extended or retracted. Actuatable member 124 is coupled to the clevis 60 and functions to rotate and raise the cam follower 70 about through pin 56.

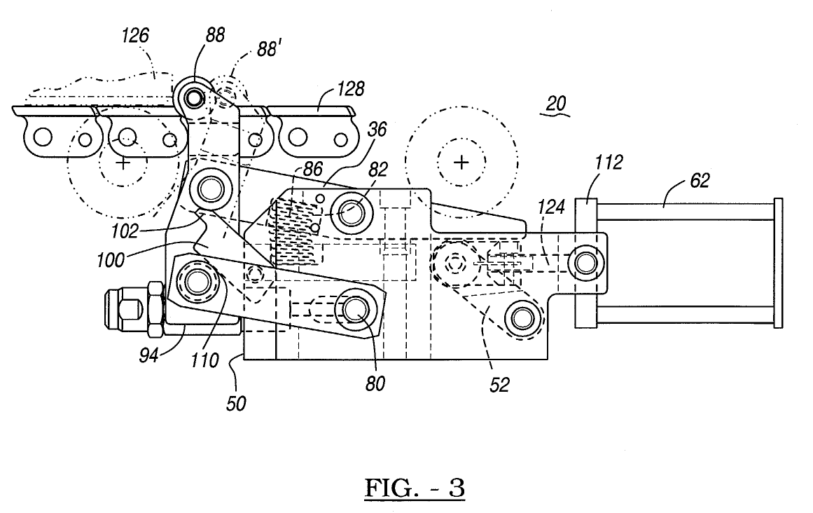

Referring generally to FIG. 3, stop mechanism 20 of the present invention is shown in its working environment. Shown is pallet 126 engaged with urethane stop wheels 87 and 90 of stop arm 24. Stop mechanism 20, which is generally disposed beneath a conveyor 128, functions to stop a pallet or other moving article on a conveyor during a manufacturing operation. As can be seen, pallet stop 20 is in a stop position when solenoid actuation member 124 is in its extended position. By extending solenoid actuation arm 124, pivot arm 52 is rotated into a lowered position. This brings cam follower 70 to a lowered position and allows actuator arm 36 to rotate about central location 44. As can be seen, coil spring 82 biases actuator arm 36 about central pivot location 44, thus allowing urethane stop wheels 87 and 90 on stop arm 24 to move to an engaged position 87′.

Shock assembly 94 absorbs energy imparted by through pin 80 upon the impacting of the pallet 126 onto the urethane wheels 87 and 90. As can be seen, tooth 102 of latch 100 is engaged with through pin 41. Tooth bearing surface 104 is pressed against through pin bearing surface 106. A latch 100 is further supported on the first sliding surface 108 by second through pin bearing surface 110 of coupling pin 33.

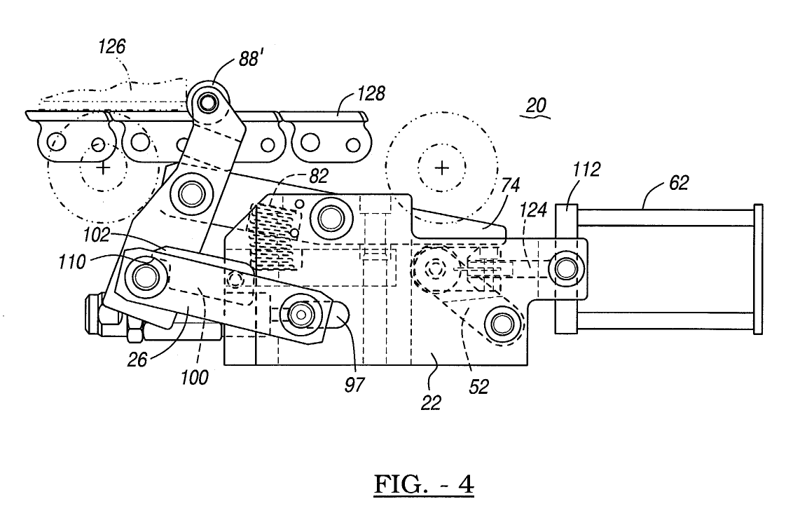

As best seen in FIG. 4, once stop arm 24 is moved from its first position to a second position, tooth 102 of latch 100 drops onto second through pin bearing surface 110. Coil spring 82 continues to apply force onto the actuating arm 36 which biases second end 74 of actuating arm 36 into a lower position. Further, the movement of stop arm 24 causes through pin 80 to move away from a first portion 97 of the generally horizontal slots 76, 78. This causes the pair of links 26 and 28 to rotate slightly about through pin 80. Additionally, links 26 and 28 slide toward the first end 50 of the stop body 22.

As best seen in FIG. 5, a stop mechanism 20 is shown in its retracted position. At an appropriate time, the solenoid 62 retracts its solenoid actuation member 124. This retraction pulls clevis 60 towards the solenoid and allows trunnion mounting 112 to rotate about through pin 56. This rotation causes pivot arm 52 to raise cam follower 70. Cam follower 70 engages the lower surface 72 of the second end 74 of actuator arm 36. Raising the second end 74 of the actuator arm 36 causes coil spring 82 to compress between the central base 81 of stop body 22 and the lower surface 72 of actuator arm 36. The rotation about actuator arm central pivot point 42 causes the actuator arm first end 40 to drop with respect to the stop body 22. This lowers stop arm 24 and related urethane stop wheels 87 and 90. As can be seen, pallet 126 is now free to move forward on the conveyor 128. Additionally shown, piston drive member 96 of the shock assembly 94 is extended. This causes through pin 80 to slide in the generally horizontal slots 76 and 78 of the stop body 22. In doing so, links 26 and 28 are rotated into a horizontal configuration. Further shown is the compression of the coil spring 82. In compressing the coil spring 82, actuator arm 36 is additionally placed in a generally horizontal configuration.

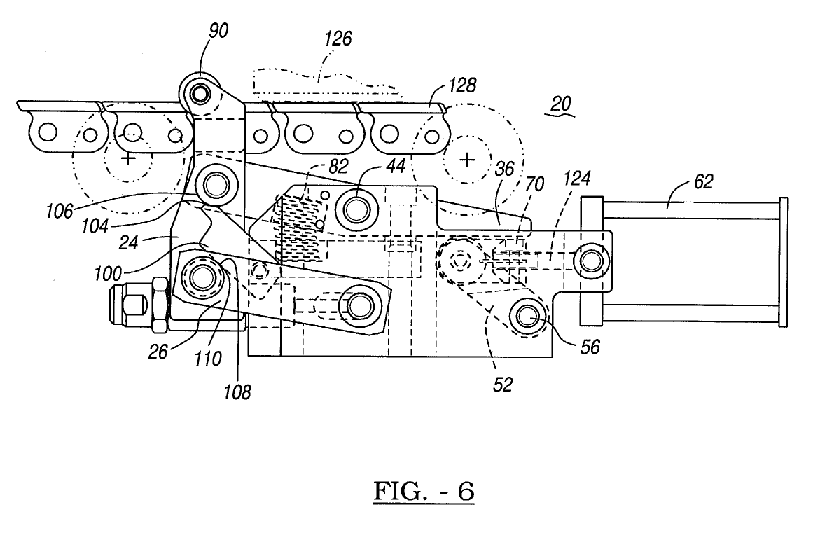

As best seen in FIG. 6, once pallet 126 has passed the stop mechanism 20 on conveyor 128, stop arm 24 is allowed to return to its stop position. Urethane wheels 87 and 90 are now again up above the conveyor 128. Solenoid 62 extends solenoid actuation member 124, thus rotating pivot arm 52 about through pin 56. In doing so, cam follower 70 is rotated into a lower position. This allows coil spring 82 to rotate the actuation arm 36 about its central pivot point 44. The tooth bearing surface 104 of latch 100 then travels up to engage with the first through pin bearing surface 106. Additionally, the pair of links 26 and 28 are slightly rotated until the second through pin bearing surface 110 engages the first sliding surface 108 of latch 100.

While the preferred embodiment of the stop mechanism has been disclosed, variations can be made which are covered by the present invention. For example, the cam follower can be configured to apply forces to the top surface of the actuator arm. In this configuration, the actuation of the solenoid must be modified. Further, the latch can be positioned in different locations within the system to regulate movement of the stop arm. Moreover, additional linkages and camming devices can be employed to achieve the same function. The description of the invention is merely exemplary in nature and, thus, variations that do not depart from the gist of the invention are intended to be within the scope of the invention. Such variations are not to be regarded as a departure from the spirit and scope of the invention.

We claim:

1. A stop assembly for stopping a moving object on a conveyor system, the stop assembly comprising:
a base;
a stop assembly operable to stop a moving object, a stop arm being rotatable and translatable substantially perpendicular to said conveyor;
an actuator arm coupled to said stop arm, said actuator arm being rotatable;
a cam follower operatively coupled to said actuator arm to rotate said actuator arm; and
at least one linkage rotatably mounted to said stop arm at a first end, said linkage having a second end which is slidably mounted to said base.

2. The stop assembly according to claim 1 further comprising a solenoid coupled to said cam follower.

3. The stop assembly according to claim 2 wherein said solenoid is configured to move said cam follower generally perpendicular to the conveyor.

4. The stop assembly according to claim 2 wherein said solenoid is mounted to said base.

5. The stop assembly according to claim 1 wherein said actuator arm is rotatable about a central location on said base.

6. The stop assembly according to claim 1 wherein said second end is rotatably mounted to said base.

7. The stop assembly according to claim 1 further comprising a shock absorber coupled to said linkage.

8. The stop assembly according to claim 1 wherein said stop arm further comprises at least one stop wheel.

9. A pallet stop for stopping a pallet on a conveyor system comprising:
a base;
a stop arm rotatable about a center and translatable with respect to the base, said stop arm having a first pallet engaging position and a second pallet releasing position;
an actuator arm coupled to said stop arm, said actuator arm being configured to regulate the translation of the said stop arm;
a cam follower operatively coupled to said actuator arm to rotate said actuator arm;
a linkage coupled to said stop arm, said linkage being configured to regulate the rotation of said stop arm;
wherein said actuator arm is configured to translate said stop arm; and
wherein movement of the actuator arm and linkage allows the stop arm to move from its first pallet engaging position to its pallet releasing position.

10. The pallet stop according to claim 9 wherein said actuator arm is rotatable about a central location a said base.

11. The pallet stop according to claim 10 wherein said second end is rotatably mounted to said base.

12. A pallet stop according to claim 9 further comprising a solenoid coupled to said actuator arm.

13. The pallet stop according to claim 12 wherein said solenoid is configured to move said cam follower generally perpendicular to the conveyor.

14. The pallet stop according to claim 13 further comprising a cam follower coupled to said actuator arm, and wherein said solenoid is configured to move said cam follower generally perpendicular to the conveyor.

15. The pallet stop according to claim 12 wherein said solenoid is mounted to said base.

16. The pallet stop according to claim 9 further comprising a shock absorber coupled to said linkage.

17. The pallet stop according to claim 9 wherein said stop arm further comprises at least one stop wheel.

18. The pallet stop according to claim 9 further comprising a cam follower operatively coupled to said actuator arm to rotate said actuator arm.

19. A conveyor system for transporting moving objects comprising:
a conveyor configured to move an object;
a stop operably stopping the object on a conveyor system comprising:
a base;
a stop arm rotatable and translatable with respect to a fixed point, said stop arm having a first object engaging position and a second object releasing position;
an actuator arm coupled to said stop arm, said actuator arm being configured to regulate the movement of said stop arm;
a cam follower operatively coupled to said actuator arm to rotate said actuator arm;
a linkage coupled to said stop arm, said linkage being configured to regulate the rotation of said stop arm;
wherein said actuator arm is configured to move said stop arm; and
wherein movement of the actuator arm and linkage allows the stop arm to move from its first object engaging position to its object releasing position.

20. The conveyor system according to claim 19 wherein said stop further comprises a solenoid coupled to said actuator arm.

21. The conveyor system according to claim 20 wherein said solenoid is configured to move said cam follower generally perpendicular to the conveyor.

22. The conveyor system according to claim 22 wherein said stop comprises a cam follower coupled to said actuator arm, and wherein said solenoid is configured to move said cam follower generally perpendicular to the conveyor.

23. The conveyor system according to claim 20 wherein said solenoid is mounted to said base.

24. The conveyor system according to claim 19 wherein said actuator arm is rotatable about a central location a said base.

25. The conveyor system according to claim 20 wherein said second end is rotatably mounted to said base.

26. The conveyor system according to claim 19 wherein said stop further comprises a shock absorber coupled to said linkage.

27. The conveyor system according to claim 19 wherein said stop arm further comprises at least one stop wheel.

28. The conveyor system according to claim 19 wherein said stop further comprises a cam follower operatively coupled to said actuator arm to rotate said actuator arm.

29. A method for stopping an article on a conveyor system comprising:
providing a conveyor configured to transport the article;
providing a stop position adjacent said conveyor, said stop having a stop arm rotatable and translatable with respect to said conveyor, said stop arm having a first object engaging position and a second release position, an actuator arm coupled to the stop arm configured to regulate translation of said stop arm, a cam follower operably coupled to said actuator arm to apply forces to said actuator arm, wherein said actuator arm is configured to translate said stop arm and wherein movement of said actuator arm allows said stop arm to move from the first object engaging position to the second release position.

30. The method according to claim 29 wherein providing a stop includes providing a linkage configured to regulate the rotation of said stop arm.
